(19) United States
(12) Patent Application Publication
(10) Pub. No.: US 2021/0013527 A1
(43) Pub. Date: Jan. 14, 2021

(54) GAS SUPPLY SYSTEM FOR FUEL CELL VEHICLE

(71) Applicant: Dalian University of Technology, Dalian (CN)

(72) Inventors: Hongxin You, Dalian (CN); Zhao Liu, Dalian (CN); Runjie Liu, Dalian (CN)

(21) Appl. No.: 17/030,469

(22) Filed: Sep. 24, 2020

Related U.S. Application Data
(63) Continuation-in-part of application No. PCT/CN2019/080790, filed on Apr. 1, 2019.

(30) Foreign Application Priority Data
Aug. 19, 2018 (CN) 201810944410.X

(51) Int. Cl. H01M 8/04082; H01M 8/04111; H01M 8/0438; H01M 8/04746; H01M 8/04992

(52) U.S. Cl. CPC H01M 8/04201; H01M 8/04111; H01M 2250/20; H01M 8/04753; H01M 8/04992; H01M 8/04388

(57) ABSTRACT

A gas supply system, including: a hydrogen cylinder, a depressurizing solenoid valve, a multi-purpose compressor, pressure sensors, and a control system. The hydrogen cylinder is provided thereon with the depressurizing solenoid valve or is connected to the depressurizing solenoid valve via a first pipeline. An outlet of the depressurizing solenoid valve is connected to a hydrogen inlet of the multi-purpose compressor. Air is sucked into the multi-purpose compressor and compressed therein, and compressed air is directly used for a cathode of a fuel cell stack. A first pressure sensor is arranged at the second pipeline between the depressurizing solenoid valve and the multi-purpose compressor, and a second pressure sensor is arranged at the third pipeline which is configured for discharging the compressed gas. The control system is in electrical connection with the depressurizing solenoid valve, the first pressure sensor, the second pressure sensor, and the multi-purpose compressor.

### CROSS-REFERENCE TO RELATED APPLICATIONS

This application is a continuation-in-part of International Patent Application No. PCT/CN2019/080790 with an international filing date of Apr. 1, 2019, designating the United States, now pending, and further claims priority benefits to Chinese Patent Application No. 201810944410.X filed Aug. 19, 2018. The contents of all of the aforementioned applications, including any intervening amendments thereto, are incorporated herein by reference.

### BACKGROUND

### Technical Field

The present application relates to the technical field of energy saving in new energy vehicle systems, and more particularly to a gas supply system for a fuel cell vehicle.

### Description of the Related Art

A typical hydrogen fuel cell vehicle needs oxygen as well as hydrogen. Hydrogen is generally compressed with a relatively high pressure and stored in a high pressure gas cylinder in which a storage pressure may reach 70 MPa. The oxygen generally comes from air, compressors or blowers are often used to overcome the resistance in channels or pipelines of the cell and transport the air containing the oxygen to the cathode channel of the cell, such that the oxygen has a certain kinetic energy to penetrate a cathode catalytic layer of the fuel cell for carrying out related electrochemical reactions.

The compressing of the air by the compressor or the blower has to consume the electricity generated by the fuel cell in order to provide the required motive power, resulting that the electricity generated from the hydrogen cannot be completely utilized for driving the vehicle, thereby reducing the travel distance and the fuel utilization rate of the fuel cell vehicle. In addition, due to the limited space within the vehicle, it is not advisable for the hydrogen-oxygen fuel cell vehicle to use a gas cylinder to store the air.

A typical gas supply system for a new energy vehicle includes: a two-stage air compressor, a fuel cell system, an air-cooled heat exchanger, and an air brake system. Compressed air generated by the air compressor is introduced to an expander for recovering the pressure energy, and cold energy and heat are recovered from the remaining cold and hot gas in the reactions in the cell. However, the pressure recovered by the system is provided by the air compressor, and such kind of energy recovery has very low efficiency, not only wasting the electricity generated from the hydrogen, but also increasing the complexity of the system.

The high-pressure hydrogen cylinder of the hydrogen-oxygen fuel cell vehicle is rich in energy, including the chemical energy as well as the pressure energy. It is desired to develop an energy-saving gas supply system which utilizes the pressure energy to drive the air compressor, thereby reducing the electricity generated by the fuel cell.

### SUMMARY

In view of the above-described problems, it is one objective of the present application to provide an energy-saving gas supply system for a fuel cell vehicle that can utilize the pressure energy of the high-pressure hydrogen cylinder and therefore drive the air compressor to pressurize the air of a normal pressure, such that the pressurized air can be utilized in the hydrogen fuel cell stack, and the pressure energy of the hydrogen is directly converted into the pressure energy of the air, thereby greatly improving the utilization rate of energy.

To achieve the above object, there is provided an energy-saving gas supply system for a fuel cell vehicle. The energy-saving gas supply system comprises: a hydrogen cylinder; a depressurizing solenoid valve; a multi-purpose compressor, the multi-purpose compressor comprising a hydrogen inlet and an air inlet; pressure sensors, the pressure sensors comprising: a first pressure sensor and a second pressure sensor; a control system; and pipelines, the pipelines comprising: a first pipeline, a second pipeline, and a third pipeline. The hydrogen cylinder is provided thereon with the depressurizing solenoid valve or is connected to the depressurizing solenoid valve via the first pipeline. An outlet of the depressurizing solenoid valve is connected to the hydrogen inlet of the multi-purpose compressor. Air is sucked into the multi-purpose compressor via the air inlet and compressed in the multi-purpose compressor, and compressed air is directly used for a cathode of a fuel cell stack. The first pressure sensor is arranged at the second pipeline between the depressurizing solenoid valve and the multi-purpose compressor, and the second pressure sensor is arranged at the third pipeline which is configured for discharging the compressed gas. The control system is a programmable logic controller, and the programmable logic controller is in electrical connection with the depressurizing solenoid valve, the first pressure sensor, the second pressure sensor, and the multi-purpose compressor.

When a pressure of the hydrogen discharged out of the depressurizing solenoid valve is not high enough to drive the multi-purpose compressor to work, or the pressure of the hydrogen detected by the first pressure sensor is lower than an inlet pressure for automatic working of the multi-purpose compressor set by the programmable logic controller, or when the air outlet pressure detected by the second pressure sensor is lower than the air pressure set by the programmable logic controller, the control system is configured for: starting a power supply system for the multi-purpose compressor to drive the multi-purpose compressor with electricity such that the hydrogen and the air are compressed and supplied to the fuel cell stack; and in such condition, the controller system is further configured to trigger an alarm to indicate that the fuel is insufficient.

When the hydrogen is re-filled, the pressure reaches a normal value, and the alarm is stopped, the control system is configured to cut off an external power supply of the multi-purpose compressor, such that the entire gas supply system works normally.

In a class of this embodiment, the control system is a S7-200 programmable logic controller.

Advantages of the energy-saving gas supply system according to embodiments of the present application are summarized as follows:

The energy-saving gas supply system comprises: the hydrogen cylinder, the depressurizing solenoid valve, the multi-purpose compressor, the pressure sensors, and the control system. The control system adopts the programmable logic controller. The first pressure sensor is arranged at the second pipeline between the depressurizing solenoid valve and the multi-purpose compressor, and the second pressure sensor is arranged at the third pipeline which is configured for discharging the compressed gas. When the pressure of the hydrogen discharged out of the depressurizing solenoid valve is not high enough to drive the multi-purpose compressor to work, or when the air outlet pressure detected by the second pressure sensor is lower than the air pressure set by the programmable logic controller, the control system is configured for starting the power supply system for the multi-purpose compressor to drive the multi-purpose compressor with electricity such that the hydrogen and the air are compressed and supplied to the fuel cell stack. The energy-saving gas supply system has simple structure, occupies a small space, and is easy centralization. The pressure energy of the high-pressure hydrogen cylinder is used to drive the air compression device to pressurize the atmospheric air, such that the pressurized air can be used by the hydrogen fuel cell stack, in this way, the pressure energy of the hydrogen is converted into the pressure energy of the air, thereby greatly improving the energy utilization rate.

### BRIEF DESCRIPTION OF THE DRAWINGS

The present application is described hereinbelow with reference to accompanying drawings, in which:

FIG. 1 is a schematic diagram of an energy-saving gas supply system for a fuel cell vehicle according to an embodiment of the present application; and

FIG. 2 is a schematic diagram of a S7-200 programmable logic controller according to an embodiment of the present application.

In the drawings, the following reference numerals are adopted:

1: Hydrogen cylinder; 2: Depressurizing solenoid valve; 3: Multi-purpose compressor; 4a: First pressure sensor; 4b: Second pressure sensor; and 5: Control system.

### DETAILED DESCRIPTION OF THE EMBODIMENTS

Detailed description of the present application will be given below in conjunction with accompanying drawings.

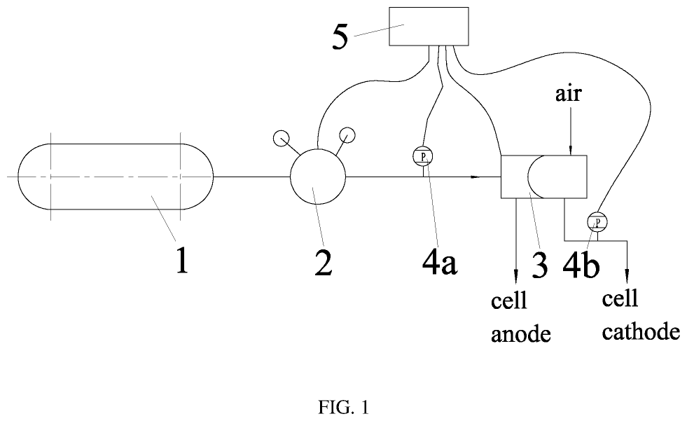

FIG. 1 is a schematic diagram of an energy-saving gas supply system for a fuel cell vehicle according to an embodiment of the present application. The energy-saving gas supply system for a fuel cell vehicle comprises: a hydrogen cylinder 1, a depressurizing solenoid valve 2, a multi-purpose compressor 3, pressure sensors, and a control system 5. The pressure sensors comprises: a first pressure sensor 4a and a second pressure sensor 4b. The hydrogen cylinder 1 is connected to the depressurizing solenoid valve 2 via a first pipeline, an outlet of the depressurizing solenoid valve 2 is connected to a hydrogen inlet of the multi-purpose compressor 3, air is sucked into the multi-purpose compressor 3 via an air inlet thereof and compressed in the multi-purpose compressor 3, and the compressed air is discharged out of the multi-purpose compressor 3 via an air outlet thereof and is directly used for a cathode of a fuel cell stack. The air introduced into the air inlet of the multi-purpose compressor 3 is the atmospheric air after filtration. Hydrogen gas with relatively low pressure discharged out of the hydrogen outlet of the multi-purpose compressor is directly used for an anode of the fuel cell stack. The first pressure sensor 4a is arranged at the hydrogen inlet, and the second pressure sensor 4b is arranged at an air outlet. The control system 5 adopts a programmable logic controller, and the programmable logic controller is in electrical connection with the depressurizing solenoid valve 2, the first pressure sensor, the second pressure sensor, and the multi-purpose compressor 3, and is configured for controlling actions of the depressurizing solenoid valve 2 and the multi-purpose compressor 3. Both the inlet and the outlet of the depressurizing solenoid valve 2 function in conveying the hydrogen, and such solenoid valve is a valve configured for controlling the hydrogen and functions in depressurizing the hydrogen from the hydrogen cylinder and leading the depressurized hydrogen out. The system according to an embodiment of the present application is particularly used as a gas supply system for a fuel cell, which only requires gas supply at the cathode and the anode. As shown in FIG. 1, the compressed hydrogen is supplied to the anode, and the compressed air is supplied to the cathode, both the hydrogen and the air are directly introduced into the subsequent stack for reaction thereby generating electricity.

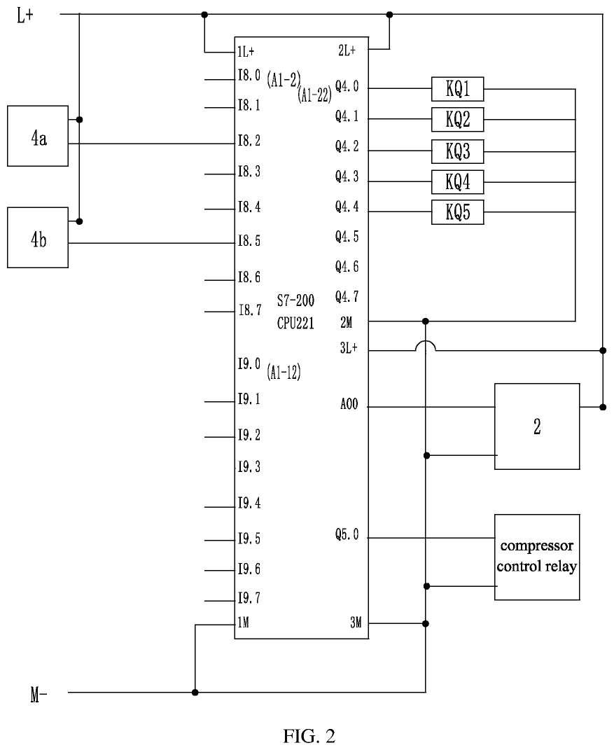

FIG. 2 is a schematic diagram of a programmable logic controller. The first pressure sensor 4a, the second pressure sensor 4b, the depressurizing solenoid valve 2, and a compressor control relay are respectively in electrical connection with the S7-200 controller. The compressor control relay is in electrical connection with the multi-purpose compressor 3, and the multi-purpose compressor 3 is driven by an onboard power supply.

When a pressure of the hydrogen discharged out of the depressurizing solenoid valve 2 is not high enough to drive the multi-purpose compressor 3 to work, that is, the pressure detected by the first pressure sensor 4a is lower than an inlet pressure for automatic working of the multi-purpose compressor 3 set by the programmable logic controller, or when the air outlet pressure detected by the second pressure sensor 4b is lower than the air pressure set by the programmable logic controller, the programmable logic controller starts the multi-purpose compressor 3 via the compressor control relay and uses the onboard power supply to drive the multi-purpose compressor 3, thereby ensuring the gas supply for the fuel cell stack. In such condition, the controller also sends out an alarm to remind users that the fuel is insufficient. When the hydrogen is re-filled, the pressure reaches a normal value, and the alarm is stopped, the control system 5 is configured to cut off an external power supply of the multi-purpose compressor 3, and the entire gas supply system works normally. When the system is turned off, the depressurizing solenoid valve 2 is closed and the system stops working.

The programmable logic controller is a programmable logic controller of a digital operation operating electronic system, and is configured for controlling the production process of a machine. The simplest Siemens S7 series programmable logic controller commonly available on the market is small, fast, standardized, with network communication capabilities, stronger functions, and higher reliability. The S7-200 programmable logic controller (model 6ES7211-0BA23-0XB0, AC/DC/relay, 6 points input and 4 points output) is a micro programmable logic controller, it is suitable for automatic detection, monitoring, and control in various industries and various occasions, the powerful function of S7-200 PLC makes it capable of implementing its complicated control function either in stand-alone operation or connected in a network.

The energy-saving gas supply system according to the above embodiments of the present application has simple structure, occupies a small space, and is easy centralization. The pressure energy of the high-pressure hydrogen cylinder is used to drive the air compression device to pressurize the atmospheric air, such that the pressurized air can be used by the hydrogen fuel cell stack, in this way, the pressure energy of the hydrogen is converted into the pressure energy of the air, thereby greatly improving the energy utilization rate.

While particular embodiments of the present application have been shown and described, it will be obvious to those skilled in the art that changes and modifications may be made without departing from the present application in its broader aspects, and therefore, the aim in the appended claims is to cover all such changes and modifications as fall within the true spirit and scope of the present application.

What is claimed is:

1. A gas supply system for a fuel cell vehicle, the gas supply system comprising:
a hydrogen cylinder;
a depressurizing solenoid valve;
a multi-purpose compressor, the multi-purpose compressor comprising a hydrogen inlet and an air inlet;
pressure sensors, the pressure sensors comprising: a first pressure sensor and a second pressure sensor;
a control system; and
pipelines, the pipelines comprising: a first pipeline, a second pipeline, and a third pipeline;
wherein
the hydrogen cylinder is provided thereon with the depressurizing solenoid valve or is connected to the depressurizing solenoid valve via the first pipeline;
an outlet of the depressurizing solenoid valve is connected to the hydrogen inlet of the multi-purpose compressor;
air is sucked into the multi-purpose compressor via the air inlet and compressed in the multi-purpose compressor, and compressed air is directly used for a cathode of a fuel cell stack;
the first pressure sensor is arranged at the second pipeline between the depressurizing solenoid valve and the multi-purpose compressor, and the second pressure sensor is arranged at the third pipeline which is configured for discharging the compressed gas;
the control system is a programmable logic controller, and the programmable logic controller is in electrical connection with the depressurizing solenoid valve, the first pressure sensor, the second pressure sensor, and the multi-purpose compressor;
when a pressure of the hydrogen discharged out of the depressurizing solenoid valve is not high enough to drive the multi-purpose compressor to work, or the pressure of the hydrogen detected by the first pressure sensor is lower than an inlet pressure for automatic working of the multi-purpose compressor set by the programmable logic controller, or when the air outlet pressure detected by the second pressure sensor is lower than the air pressure set by the programmable logic controller, the control system is configured for:
starting a power supply system for the multi-purpose compressor to drive the multi-purpose compressor with electricity such that the hydrogen and the air are compressed and supplied to the fuel cell stack;
and in such condition, the controller system is further configured to trigger an alarm to indicate that the fuel is insufficient; and
when the hydrogen is re-filled, the pressure reaches a normal value, and the alarm is stopped, the control system is configured to cut off an external power supply of the multi-purpose compressor, such that the entire gas supply system works normally.

2. The gas supply system according to claim 1, wherein the control system is a programmable logic controller.
